(19) United States
(12) Patent Application Publication
(10) Pub. No.: US 2021/0167929 A1
(43) Pub. Date: Jun. 3, 2021

(54) COMMUNICATION DEVICE

(71) Applicant: NTT DOCOMO, INC., Tokyo (JP)

(72) Inventors: Ryosuke Osawa, Chiyoda-ku, Tokyo (JP); Kazuaki Takeda, Chiyoda-ku, Tokyo (JP); Huan Wang, Beijing, Haidian District (CN); Xufei Zheng, Beijing, Haidian District (CN); Xiaolin Hou, Beijing, Haidian District (CN)

(73) Assignee: NTT DOCOMO, INC., Tokyo (JP)

(21) Appl. No.: 17/054,341

(22) PCT Filed: May 30, 2018
(86) PCT No.: PCT/JP2018/020851

§ 371 Date: Nov. 10, 2020

(51) Int. Cl. H04L 5/00; H04W 72/04; H04B 1/713

(52) U.S. Cl. CPC H04L 5/0089; H04W 72/0446; H04L 5/16; H04L 5/0058; H04B 1/713; H04W 72/0453

(57) ABSTRACT

A communication device includes a transmitter that transmits data; and a controller that generates, in response to a predetermined trigger, a request signal including information on a time and frequency location of a radio resource to be used by the transmitter.

### TECHNICAL FIELD

The present invention relates to a communication device in a radio communication system.

### BACKGROUND ART

In LTE (Long Term Evolution) and LTE successor systems (e.g., LTE Advanced (LTE-A), New Radio (NR) (which is also referred to as 5G)), sidelink (which is also referred to as D2D (Device to Device)) technology has been studied in which communication devices, such as a UE, communicate directly without using base stations (Non-Patent Document 1).

In addition, it has been studied to achieve V2X (Vehicle to Everything), and drafting of specifications has progressed. Here, V2X is a part of the Intelligent Transport Systems (ITS), and as illustrated in FIG. 1, it is a generic term for V2V (Vehicle to Vehicle), which refers to a form of communication between vehicles; V2I (Vehicle to Infrastructure), which refers to a form of communication between a vehicle and a road-side unit (RSU: Road-Side Unit) installed at a roadside; V2N (Vehicle to Nomadic device), which means a form of communication between a vehicle and a mobile terminal of a driver; and V2P (Vehicle to Pedestrian), which means a form of communication between a vehicle and a mobile terminal of a pedestrian.

### PRIOR ART DOCUMENT

### Non-Patent Document

Non-Patent Document 1: 3GPP TS 36.213 V14.3.0 (2017-06)

### SUMMARY OF THE INVENTION

### Problem to be Solved by the Invention

In D2D, because a common bandwidth is used for transmission and reception, half duplex communication (Half duplex) is performed, and one communication device is unable to perform transmission and reception of D2D communication simultaneously. Furthermore, when a communication device autonomously selects a transmission resource, the transmission resource selected by the communication device may conflict with a transmission resource selected by another communication device.

In D2D communication, there is a need for technology that can reduce the probability of a contention of transmission resources to transmit data.

### Means for Solving the Problem

According to the disclosed technology, there is provided a communication device including a transmitter that transmits data; and a controller that generates, in response to a predetermined trigger, a request signal including information on a time and frequency location of a radio resource to be used by the transmitter.

### Advantage of the Invention

According to the disclosed technology, a technique can be provided such that, in D2D communication, the probability of contention over transmission resources for transmitting data can be reduced.

### BRIEF DESCRIPTION OF DRAWINGS

FIG. 1 is a diagram illustrating V2X;

FIG. 2A is a diagram illustrating a sidelink;

FIG. 2B is a diagram illustrating a sidelink;

FIG. 3 is a diagram illustrating a MAC PDU used for sidelink communication;

FIG. 4 is a diagram illustrating a format of an SL-SCH subheader;

FIG. 5 is a diagram illustrating an example of a channel structure used in a sidelink;

FIG. 6 is a diagram illustrating an example of a configuration of a radio communication system according to an embodiment;

FIG. 7 is a diagram illustrating a resource selection operation of a communication device;

FIG. 8A is a diagram illustrating an example of a resource collision in a half-duplex communication method;

FIG. 8B is a diagram illustrating an example of a resource collision between communication devices;

FIG. 9 is a diagram illustrating an example of Dynamic Resource Exchange;

FIG. 10 is a diagram illustrating an example of resource hopping with respect to time and frequency;

FIG. 11 is a diagram illustrating an example of a hopping resource unit;

FIG. 12 is a diagram illustrating an example of configuring a hopping pattern for a hopping resource unit;

FIG. 13 is a diagram illustrating an example of a hopping pattern map;

FIG. 14 is a diagram illustrating an example of a method of applying Precoder cycling or Antenna switching.

FIG. 15 is a diagram illustrating an example of a method for applying Precoder cycling or Antenna switching;

FIG. 16 is a diagram illustrating an example of a functional configuration of a base station 10 according to an embodiment;

FIG. 17 is a diagram illustrating an example of a functional configuration of a communication device 20 according to an embodiment; and

FIG. 18 is a diagram illustrating an example of a hardware configuration of a base station 10 and a communication device 20 according to an embodiment.

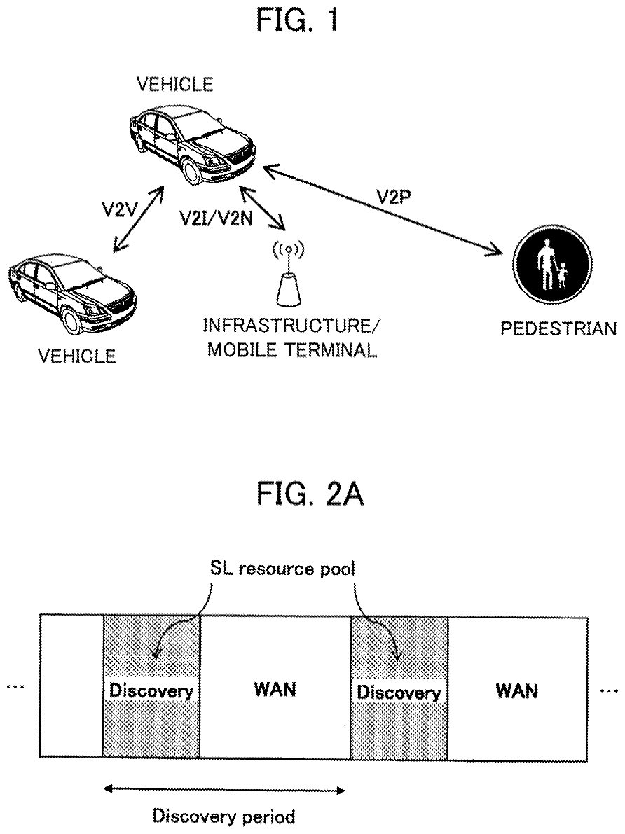

### EMBODIMENTS OF THE INVENTION

In the following, embodiments of the present invention (the embodiments) are described with reference to the drawings. It should be noted that the embodiments described below are merely an example, and the embodiments to which the present invention is applied are not limited to the following embodiments.

Although a method of direct communication between communication devices in this embodiment is assumed to be a sidelink (SL) of LTE or NR, the method of direct communication is not limited to this method. In addition, the name “sidelink” is an example, and the name “sidelink” need not be used, and the UL may include a function of SL.

UL and SL may also be distinguished by differences in one or more of the time resources, frequency resources, time and frequency resources, reference signals that are referred to for determining a pathloss during transmission power control, and reference signals used for establishing synchronization (PSSS/SSSSS).

For example, in UL, a reference signal of an antenna port X is used as a reference signal to determine the pathloss during transmission power control, and, in SL (including UL used as SL), a reference signal of an antenna port Y is used as the reference signal to determine the pathloss during the transmission power control.

Furthermore, although the embodiments mainly assume an example in which the communication device is installed in a vehicle, embodiments of the present invention are not limited to this example. For example, the communication device may be a terminal carried by a person, or the communication device may be a device installed in a drone or an aircraft.

(Outline of Sidelink)

In the embodiments, because a sidelink is a basic technology, an outline of the sidelink is first described, as a basic example. An example of a technique described in this specification is the technique specified in Rel. 14, etc., of 3GPP. The technique may be used in NR, or a technique other than such a technique may be used.

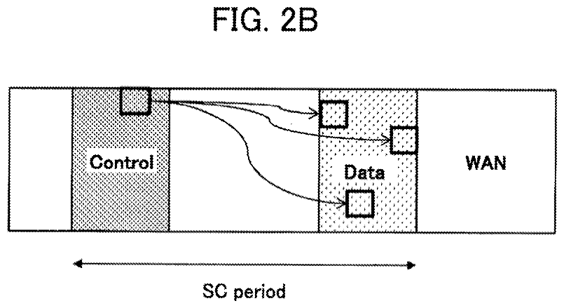

A sidelink is broadly divided into “discovery” and “communication.” For “discovery,” as illustrated in FIG. 2A, a resource pool for Discovery messages is allocated for each Discovery period, and a communication device (called a UE) transmits a Discovery message (discovery signal) within the resource pool. More specifically, there are Type 1 and Type 2b. In Type 1, the communication device autonomously selects a transmission resource from a resource pool. In Type 2b, quasi-static resources are assigned by higher-layer signaling (e.g., RRC signals).

As illustrated in FIG. 2B, for “communication,” a resource pool for SCI (Sidelink Control Information)/data transmission is periodically allocated. A transmitting communication device reports a data transmission resource (PSSCH resource pool), etc., by SCI through a resource selected from a Control resource pool (PSCCH resource pool) to a receiving side and transmits the data using the data transmission resource. For “communication,” more specifically, there are modes 1 and 2. In mode 1, resources are dynamically assigned by (E)PDCCH transmitted from a base station to a communication device. In mode 2, a communication device autonomously selects the transmission resource from a resource pool. As for a resource pool, a predefined resource is used, such as that notified by the SIB.

Furthermore, in the Rel. 14, there are modes 3 and 4 in addition to mode 1 and mode 2. In Rel-14, the SCI and data can be simultaneously transmitted (in one sub-frame) in resource blocks adjacent to each other in a frequency direction. Note that SCI may be referred to as SA (scheduling assignment).

A channel used for “Discovery” is called PSDCH (Physical Sidelink Discovery Channel). A channel for transmitting control information, such as SCI, in “Communication” is called PSCCH (Physical Sidelink Control Channel). A channel for transmitting data is called PSSCH (Physical Sidelink Shared Channel). PSCCH and PSSCH are provided with PUSCH-based structures, in which DMRSs (Demodulation Reference Signals) are inserted.

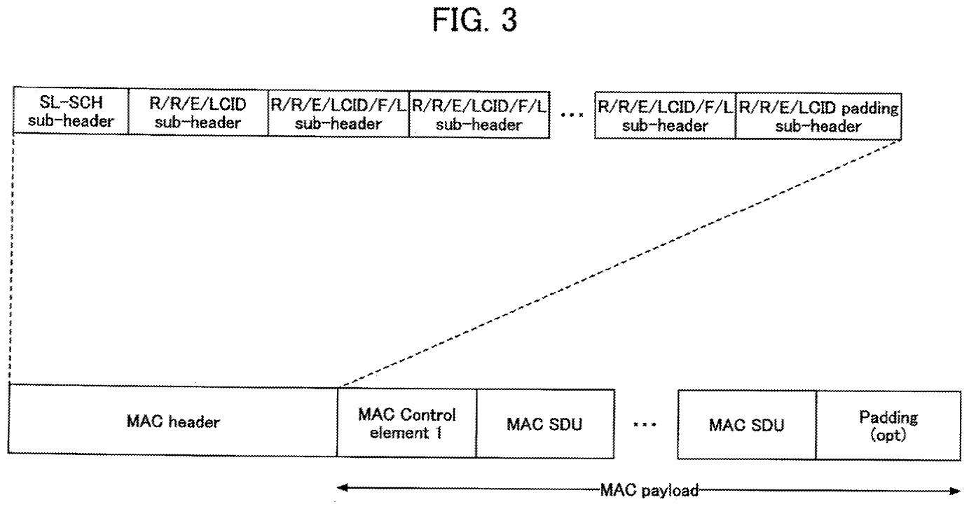

A MAC (Medium Access Control) PDU (Protocol Data Unit) used for a sidelink is formed of at least a MAC header, a MAC control element, a MAC SDU (Service Data Unit), and padding, as illustrated in FIG. 3. A MAC PDU may include any other information. A MAC header is formed of one SL-SCH (Sidelink Shared Channel) subheader and one or more MAC PDU sub-headers.

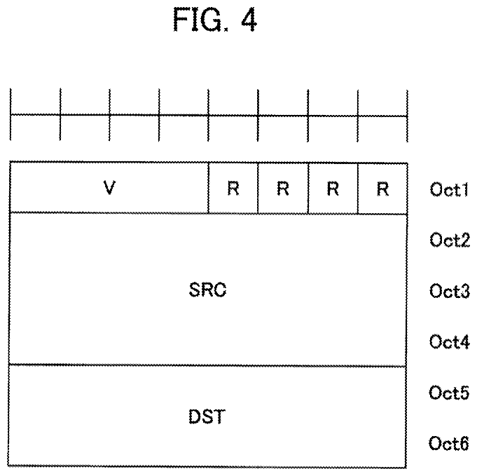

As illustrated in FIG. 4, an SL-SCH subheader is formed of a MAC PDU format version (V), transmission source information (SRC), transmission destination information (DST), a Reserved bit (R), etc. V is assigned to a beginning of an SL-SCH sub-header and indicates a MAC PDU format version used by a communication device. Information on a transmission source is configured in the transmission source information. An identifier related to a ProSe UE ID may be configured in the transmission source information. Information on a ProSe Layer-2 Group ID of a transmission destination may be configured in the transmission destination information.

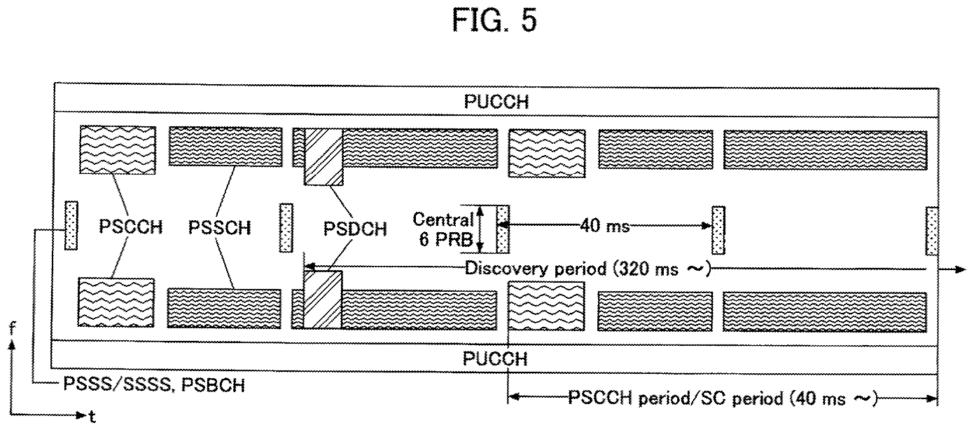

An example of a sidelink channel structure is illustrated in FIG. 5. As illustrated in FIG. 5, a PSCCH resource pool and a PSSCH resource pool used for “communication” are assigned. In addition, a PSDCH resource pool used for “discovery” is assigned with a period longer than a period of a “communication” channel.

Additionally, PSSS (Primary Sidelink Synchronization Signal) and SSSS (Secondary Sidelink Synchronization Signal) are used as synchronization signals for a sidelink. For out-of-coverage operations, for example, a PSBCH (Physical Sidelink Broadcast Channel) is used, which is for transmitting broadcast information (broadcast information), such as a system bandwidth, a frame number, and resource configuration information. PSSS/SSSS and PSBCH are transmitted, for example, in one sub-frame. PSSS/SSSS may be referred to as SSLSS.

The V2X assumed in the embodiments is a method related to “communication.” However, in the embodiments, there may be no distinction between “communication” and “discovery.” Additionally, the techniques of the embodiments may be applied to “discovery.”

(System Configuration)

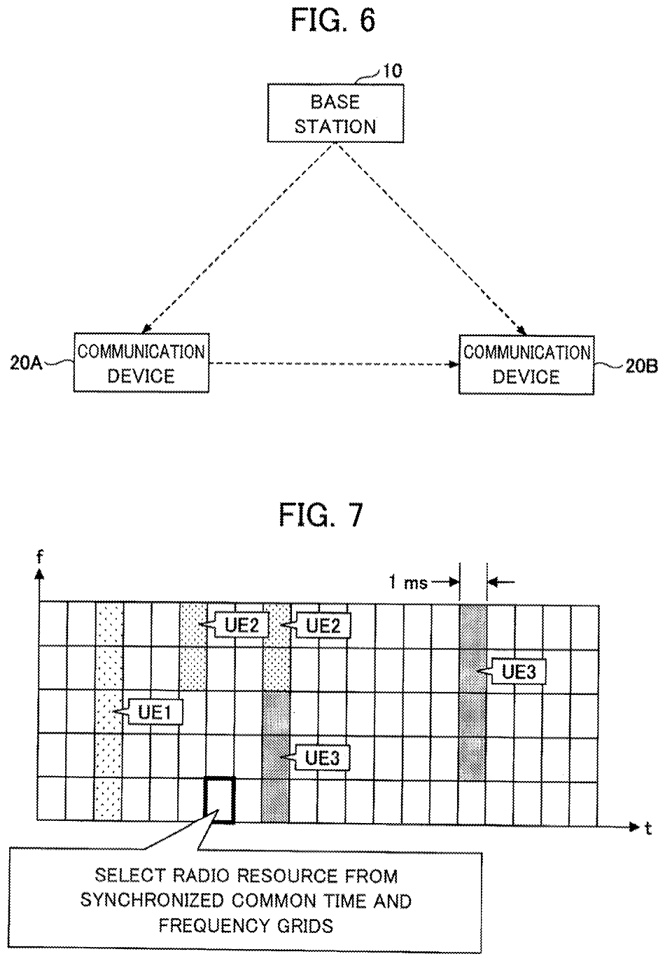

FIG. 6 is a diagram illustrating an example configuration of a radio communication system according to an embodiment. As illustrated in FIG. 6, the radio communication system according to the embodiment includes a base station 10; a communication device 20A; and a communication device 20B. Although there may actually be a large number of communication devices, FIG. 6 illustrates the communication device 20A and the communication device 20B as an example.

In FIG. 6, the communication device 20A is assumed to be on the transmitting side and the communication device 20B is assumed to be on the receiving side. However, each of the communication device 20A and the communication device 20B is provided with a transmitting function and a receiving function. In the following, when the communication devices 20A and 20B are not particularly distinguished, they are simply denoted as “communication devices 20,” “communication devices,” etc. In FIG. 6, a case is illustrated, as an example, in which the communication device 20A and the communication device 20B are located within coverage of the base station 10. However, the operation in the embodiment can be applied to any one of a case in which all the communication devices 20 are located within the coverage of the base station 10; a case in which a portion of the communication devices 20 is located outside the coverage of the base station 10 and the remaining portion of the communication devices 20 is located within the coverage of the base station 10; and a case in which all the communication devices 20 are located outside the coverage of the base station 10.

In the embodiment, the communication device 20 is a device installed in a vehicle, such as an automobile, and the communication device 20 is provided with a cellular communication function, as a UE of LTE or NR, and a sidelink function. Furthermore, the communication device 20 includes a function for obtaining report information (position, event information, etc.), such as a GPS device, a camera, various types of sensors, etc. The communication device 20 may be a generic mobile terminal (e.g., a smartphone). The communication device 20 may be an RSU. The RSU may be a UE type RSU (which may be referred to as a gNB type UE) provided with a function of a UE, or the communication device 20 may be a BS-type RSU (which may be referred to as a gNB type RSU (micro BS) or eNB type RSU) provided with a function of a base station.

Note that the communication device 20 need not be an apparatus with one enclosure. For example, even if various types of sensors are distributed in a vehicle, a device including the various types of sensors is the communication device 20. The communication device 20 may be provided with a function for transmitting to and receiving from various types of sensors, without including the various types of sensors.

In addition, details of a transmission process of a sidelink by the communication device 20 are basically the same as those of a UL transmission process of LTE or NR. For example, the communication device 20 scrambles a code word of transmission data, modulates it to generate a complex-valued symbols, maps the complex-valued symbols (transmission signals) onto one or two layers, and performs precoding. Subsequently, the precoded complex-valued symbols are mapped onto resource elements to generate transmission signals (e.g., a complex-valued time-domain SC-FDMA signal) and transmitted from each antenna port.

In addition, the base station 10 is provided with a cellular communication function as the base station 10 in the LTE or NR and a function for enabling communication of the communication device 20 according to the embodiment (e.g., resource pool configuration, resource allocation, etc.). The base station 10 may be an RSU (gNB type RSU).

In the radio communication system according to the embodiment, the signal waveform used by the communication device 20 for the SL or UL may be an OFDMA, an SC-FDMA, or another signal waveform. In the radio communication system according to the embodiment, as an example, a frame including a plurality of sub-frames (e.g., 10 sub-frames) is formed in a time direction, and a plurality of sub-carriers is included in a frequency direction. One sub-frame or one slot is an example of a transmission time interval (TTI: Transmission Time Interval). A time length other than subframes or slots may be used as transmission time intervals. A number of slots per sub-frame may also be determined depending on the sub-carrier spacing. A number of symbols per slot may be 14.

In this embodiment, the communication device 20 may take any one of a mode 1 in which resources are dynamically assigned by (E)PDCCH ((Enhanced) Physical Downlink Control Channel) that is transmitted from the base station 10 to the communication device; a mode 2 in which the communication device autonomously selects transmission resources from a resource pool; a mode in which resources for SL signal transmission are autonomously selected (which is referred to as a mode 4 below); and a mode in which resources for SL signal transmission are assigned by the base station 10 (which is referred to as a mode 3 below). For example, the base station 10 configures a mode on the communication device 20.

As illustrated in FIG. 7, a mode 4 communication device (illustrated as a UE in FIG. 7) selects a radio resource from a synchronized common time-frequency grid. For example, the communication device 20 performs sensing in a background to identify, as candidate resources, resources with favorable sensing results that are not reserved by another communication device, and the communication device 20 selects a resource to be used for transmission from the candidate resources.

In D2D, a common frequency band is used for transmission and reception, and, as a result, half duplex communication (Half duplex) is performed. Accordingly, the communication device 20 is unable to perform transmission and reception of D2D communication simultaneously. That is, the communication device 20 is unable to receive a D2D signal while the communication device 20 is transmitting a signal.

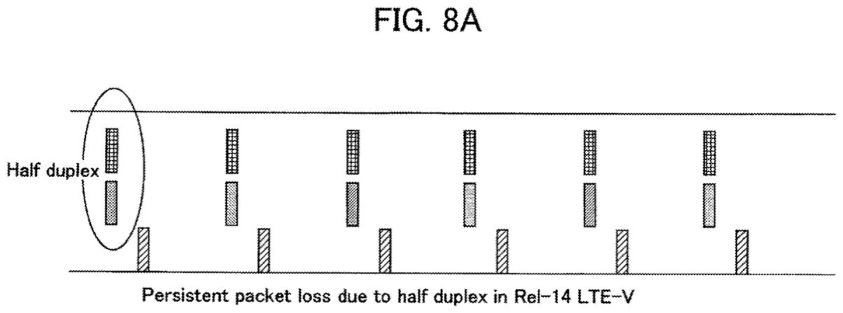

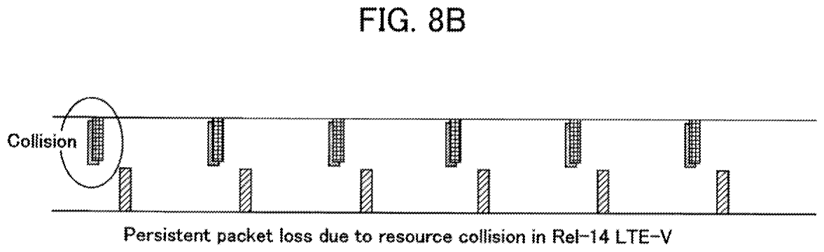

FIG. 8A illustrates a situation in which data is transmitted to a communication device 20 at a timing at which the communication device 20 performs transmission. If a collision occurs continuously between data transmission and data reception in the same communication device 20, a situation may occur in which communication by the communication device 20 is disabled.

In D2D, two types of resource allocation methods are supported: a method in which the base station 10 allocates transmission resources to the communication device 20; and a method in which the communication device 20 autonomously selects transmission resources.

When the base station 10 allocates transmission resources, a plurality of transmission resources orthogonal to each other may be allocated to the respective plurality of communication devices 20 in the coverage.

In the case of “communication,” the base station 10 dynamically signals the allocation of the transmission resources to the communication device 20 using (E) PDCCH ((Enhanced) Physical Downlink Control Channel). In the case of “discovery”, the base station 10 allocates the transmission resources by RRC (Radio Resource Control) signaling.

When the communication device 20 autonomously selects the transmission resource, the communication device 20 selects a resource from a resource pool (a candidate of time and frequency resources) and the communication device 20 transmits. As a result, a transmission resource selected by one communication device 20 may collide with a transmission resource selected by another communication device 20.

FIG. 8B is a diagram illustrating an example of the above-described case. Specifically, a plurality of communication devices 20 are provided, and a situation in which a collision of the transmission resources of the two communication devices 20 occurs continuously in time is illustrated. In this manner, if a collision of transmission resources occurs continuously over time, a situation may occur in which communications by the two communication devices 20 are disabled.

In order to reduce the probability of a resource collision as described above, a method can be considered such that, in the mode 4, for example, after the communication device 20 autonomously selects a transmission resource, a time interval until occurrence of a trigger to cause the communication device 20 to reselect a transmission resource is shortened. However, this method may be unable to reduce the probability of resource collisions because the number of times of resource reselection increases.

In order to reduce the probability of a resource collision as described above, it can be considered to apply semi-persistent scheduling (Semi Persistent Scheduling, SPS) to each of the communication devices 20. However, this method may be unable to reduce the probability of resource collision because the number of times of resource reselection increases corresponding to multiple SPSs.

In order to reduce the probability of a resource collision as described above, for example, it can be considered, in mode 3, to reduce a time interval from an allocation, by the base station 10, of a transmission resource to the communication device 20 until a next allocation, by the base station 10, of a transmission resource to the communication device 20. However, in this case, signaling (Uu signaling) for scheduling from base station 10 to communication device 20 is increased.

<Method 1>

One method for solving the above-described problems is to exchange information on time and frequency locations of candidate transmission resources used for D2D communication between the adjacent communication devices 20 to avoid collisions. In this specification, this method is referred to as Dynamic Resource Exchange.

As a situation in which this method is used, a case can be considered in which voice signals are transmitted from a vehicle using persistent scheduling, or a case can be considered in which information related to travelling, such as location information of a vehicle, is transmitted, which is to be regularly transmitted.

As cases in which transmission resources for transmitting data collide, for example, a case can be considered in which transmission resources collide when data is to be transmitted on a shared channel, and a case can be considered in which transmission resource collide when a control signal is transmitted on a control channel.

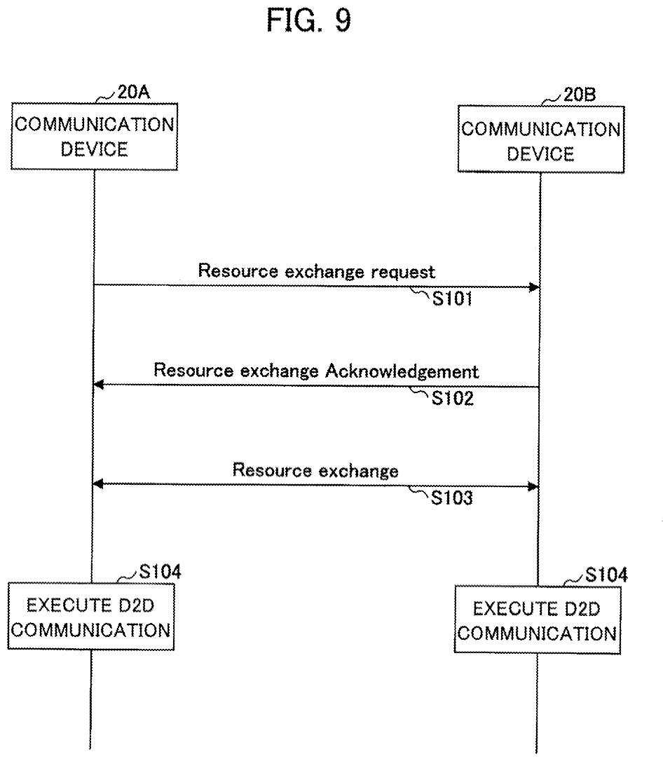

FIG. 9 is a diagram illustrating an example of Dynamic Resource Exchange. As an assumption of the description of FIG. 9, the communication device 20A and the communication device 20B are assumed to be adjacent to each other. In addition, two states are defined, as states that can be taken by the communication device 20A and the communication device 20B, which are a state in which the resource exchange is not carried out and a state in which the resource exchange is completed.

At step S101, the communication device 20A transmits a resource exchange request to the communication device 20B adjacent to the communication device 20A. Here, it is assumed that the communication device 20A and the communication device 20B do not exchange information on time and frequency locations of candidate radio resources used for D2D communication prior to step S101.

At step S102, in response to receiving a resource exchange request, the communication device 20B transmits acknowledgement information (Resource Exchange Acknowledgement) to the communication device 20A.

At step S103, the communication device 20A transmitting a resource exchange request performs a process of exchanging resources in the communication device 20A in response to receiving an Acknowledgement signal. The communication device 20B transmitting the Acknowledgement signal also performs a process of exchanging resources within the communication device. In this case, as a state of the communication device 20A and a state of the communication device 20B, states may be defined that correspond to the resource exchange process in progress. In this case, the states of the communication devices 20A and 20B correspond to the states during the execution of the resource exchange process.

Upon a signal indicating completion of the resource exchange being signaled, the Dynamic Resource Exchange is completed. For example, the communication device 20A that receives a resource exchange request may transmit a signal indicating that the resource exchange has been completed to the communication device 20B that is the source of the resource exchange request after the resource exchange has been completed. Accordingly, the states of the communication devices 20A and 20B may transition from the states corresponding to the resource exchange process in progress to the states after the completion of the resource exchange. Namely, the state of the communication device 20A that transmits the resource exchange request may transition to a state in which the resource exchange has been completed and the state of the communication device 20B that receives the resource exchange request may become a state in which the resource exchange has been completed.

After the completion of the resource exchange, at step S104, each of the communication device 20A and the communication device 20B can perform D2D communication using the transmission resources selected as a result of the resource exchange.

The unit of resource exchange may be a single data (packet) or multiple data items (multiple packets). For example, the unit of resource exchange may be a sub-carrier, a resource element, a resource block, and a symbol slot (TTI), or a higher-layer PDU (Protocol Data Unit), etc. The unit of resource exchange may be pre-configured or specified by a specification.

Radio resources that can be candidates for the resource exchange may be selected from one or more radio resources that exceed a threshold that is predetermined for an index representing quality of communication, such as received power (RSRP), received quality (RSRQ, SINR), or received strength (RSSI). Here, a radio resource may be a resource block formed of a plurality of resource elements in the time and frequency domain used for transmitting and receiving data.

The resource exchange request may explicitly include information that specifies a radio resource that can be a candidate for the resource exchange.

The Acknowledgement signal may be a physical layer signal or a higher layer (MAC, RRC) signal.

If the resource exchange request includes information indicating a plurality of radio resources that can be candidates for a resource exchange, the Acknowledgement signal transmitted at step 2 may include Acknowledgement for some resources of the plurality of radio resources.

When a resource exchange request is transmitted, a radio resource for sending the resource exchange request may collide with a radio resource for transmitting a signal by another communication device. In this case, for example, a reselection of a radio resource may be performed, and a resource exchange request may be transmitted again. Furthermore, multiple communication devices may transmit resource exchange requests to a single communication device. In this case, a single communication device at the receiving side may return an Acknowledgement signal to only one of the resource exchange requests. In this case, resource exchange may be performed for only the one resource exchange request to which the Acknowledgement signal is returned.

If a resource exchange request includes information specifying a radio resource that can be a candidate for the resource exchange, the information specifying the radio resource that can be the candidate for the resource exchange may be information indicating a time and frequency location of the radio resource that can be a candidate for the resource exchange.

As a trigger for transmitting a resource exchange request by the communication device 20A, for example, the following cases can be considered: a case in which, among multiple radio resources included in a resource pool, a predetermined proportion or more of the radio resources are detected to be used by another communication device; and a case in which a ratio of failure of transmission becomes greater than or equal to a predetermined ratio. Here, the predetermined proportion or the predetermined ratio described above may vary depending on a type of service, such as being weighted according to a type of service.

At step S101, when the communication device 20A transmits a resource exchange request, and when the communication device 20A includes in the resource exchange request information on a time and frequency location of one radio resource that can be a candidate for the resource exchange, the communication device 20B receiving the resource exchange request may determine to re-select a radio resource other than the one radio resource that can be a candidate for the resource exchange as a transmission resource, if it is possible to select a radio resource other than the one radio resource that can be a candidate for the resource exchange. In this case, an Acknowledgement signal transmitted at step S102 may include information on the time and frequency location of the one radio resource that can a candidate for the above-described resource exchange. In addition to the time and frequency location information of the one radio resource that can be a candidate for the above-described resource exchange, information on a time and frequency location of a radio resource that can be selected by the above-described communication device 20B other than the one radio resource that can be a candidate of the resource exchange may be included in the Acknowledgement signal transmitted at step S102. Alternatively, only Positive Acknowledgement may be included in the Acknowledgement signal transmitted at step S102.

At step S102, in response to receiving an Acknowledgement signal including information on the time and frequency location of the above-described one radio resource that can be a candidate for the resource exchange, the communication device 20A that transmits the resource exchange request may select, as a transmission resource, the radio resource specified by the information on the time and frequency location included in the Acknowledgement signal, in the communication device 20A (step S103). The communication device 20B that transmits the above-described Acknowledgement signal at step S102 may reselect a radio resource that can be selected by the communication device 20B other than the above-described one radio resource that can be a candidate for the resource exchange (Step S103). In response to receiving, at step S102, the Acknowledgement signal including, in addition to the time and frequency location information of the above-described one radio resource that can be a candidate for the resource exchange, information on the time and frequency location of the radio resource that can be selected by the above-described communication device 20B other than the above-described one radio resource that can be a candidate of the resource exchange, the communication device 20A that transmits the resource exchange request may select, as a transmission resource, the above-described one radio resource that can be a candidate for the resource exchange specified by the information on the time and frequency location included in the Acknowledgement signal, and the communication device 20A that transmits the resource exchange request need not select the radio resource that can be selected by the above-described communication device 20B other than the above-described one radio resource that can be a candidate of the resource exchange.

In response to receiving an Acknowledgement signal including only the Positive Acknowledgement at step S102, the communication device 20A that transmits the resource exchange request may select, as a transmission resource, the one radio resource specified by the information on the time and frequency location included in the resource exchange request. In this case, the communication device 20B that transmits the Acknowledgement signal including only the Positive Acknowledgement may reselect a radio resource that can be selected by the communication device 20B other than the above-described one radio resource that can be a candidate for the resource exchange.

When the communication device 20B that receives the resource exchange request does not select a radio resource other than the one radio resource that can be a candidate for the resource exchange at step S102, the communication device 20B may determine not to reselect, as a transmission resource, a radio resource other than the one radio resource that can be a candidate for the resource exchange. Namely, the communication device 20B may determine to continue using the one radio resource that can be a candidate for the resource exchange, as the transmission resource. In this case, for example, negative response information (Negative Acknowledgement) may be included in the Acknowledgement signal to be transmitted at step S102. The communication device 20A that transmits the resource exchange request may, in response to receiving the Acknowledgement signal including the Negative Acknowledgement, reselect one radio resource that can be a candidate for the resource exchange and transmit a resource exchange request again.

When a collision of multiple radio resources is detected in the communication device 20A transmitting the resource exchange, at step S101, the communication device 20A may include, in the resource exchange request, information on time and frequency locations of one or more radio resources that can be candidates for the resource exchange. In this case, the communication device 20A may, for example, select one or more radio resources from a plurality of radio resources for which collisions have been detected, based on an index representing quality of the communication (RSRP, RSSI, etc.) and include information on time and frequency locations of the selected one or more radio resources in the resource exchange request. For example, one or more radio resources may be selected from a plurality of radio resources for which collisions have been detected in decreasing order of the RSRP.

Additionally or alternatively, one or more radio resources may be selected from a plurality of radio resources for which collisions have been detected to be used to transmit data of higher priority (e.g., from top to nth priority levels, based on the highest priority level), based on the priority attached to the data, such as ProSe Per Packet Priority (PPPP).

In response to detecting that the received resource exchange request includes information on the time and frequency locations of the plurality of radio resources that can be candidates for the resource exchange, the communication device 20B that receives the resource exchange request may select one or more radio resources that are continuously used by the communication device 20B from the plurality of radio resources that can be candidates for the resource exchange. For example, the communication device 20B may select one or more radio resources that are continuously used based on an index representing quality of communication (RSRP, RSSI, etc.) from the one or more radio resources that can be candidates for the resource exchange, and may include, in the Acknowledgement signal, information on the time and frequency locations of the one or more radio resources that are not selected by the communication device 20B, from the one or more radio resources that can be candidates for the resource exchange. Additionally or alternatively, the communication device 20B may select, as the one or more radio resources to be continuously used, one or more radio resources that are used to transmit data with a higher priority level (e.g., from top to nth priority levels, based on the highest priority level), based on the priority assigned to the data, such as ProSe Per Packet Priority (PPPP), from the plurality of radio resources that can be candidates for the resource exchange.

<Method 2>

As another method for solving the above-described problem, a method can be considered such that a time and frequency location of a transmission resource selected by the communication device 20 within one period, such as a communication period (40 ms), is hopped with respect to the time and the frequency for each period.

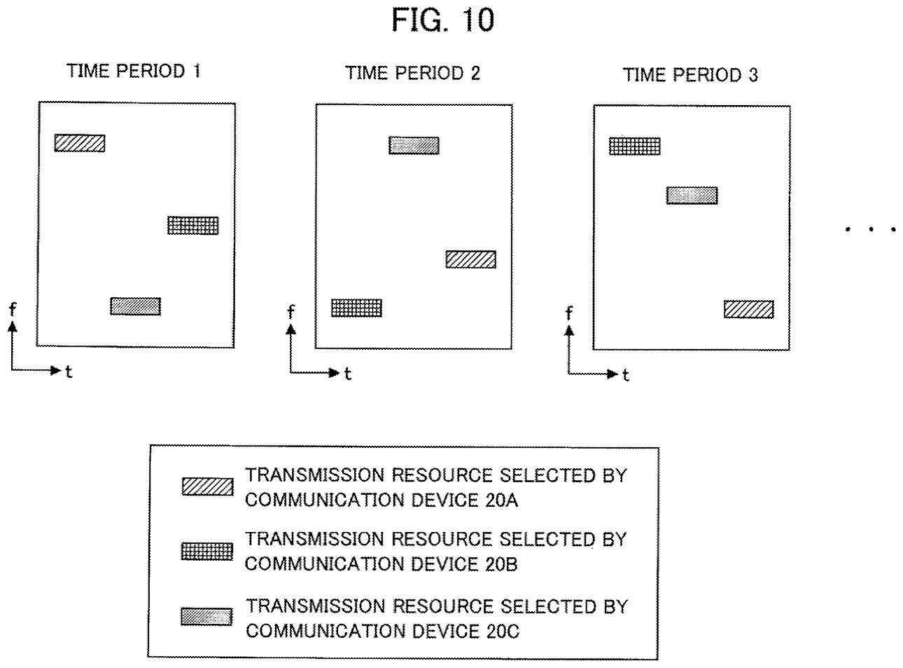

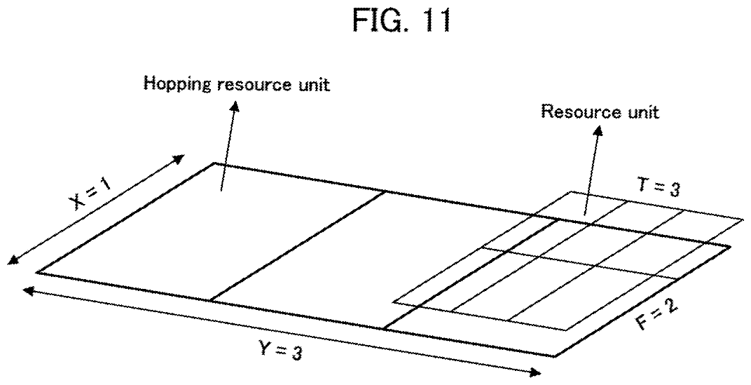

FIG. 10 is a diagram illustrating an example of resource hopping with respect to time and frequency. As illustrated in FIG. 10, a time and frequency location of a transmission resource selected by the communication device 20A within a resource pool in each time period of a time period 1, a time period 2, a time period 3, . . . , depends on the time period. Namely, a time and frequency location of a transmission resource selected by the communication device 20A within a resource pool in each time period of a time period 1, a time period 2, a time period 3, . . . , hops depending on time. As illustrated in FIG. 10, by such resource hopping, collisions of transmission resources of the plurality of communication devices 20 (e.g., the communication device 20A, the communication device 20B, and the communication device 20C) can be avoided. An example of a method of executing the resource hopping is specifically described below.

First, multiple hopping resource units are preconfigured (defined) in a predetermined resource set, such as a resource pool.

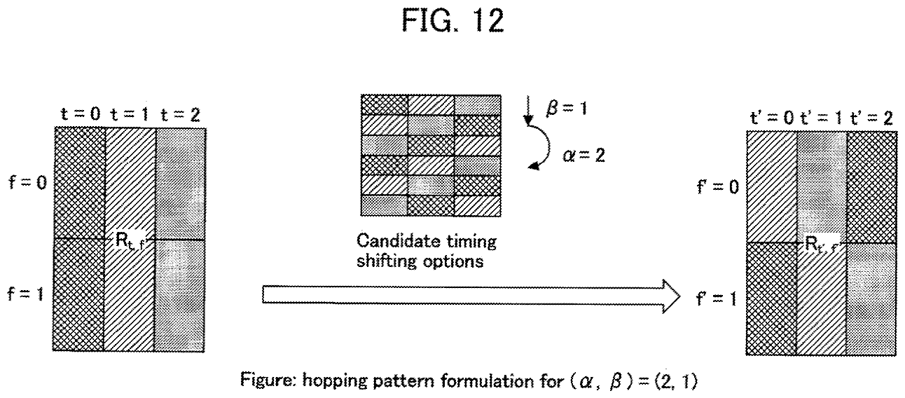

For example, as illustrated in FIG. 11, X hopping resource units are configured in the frequency domain and Y hopping resource units are configured in the time domain.

For example, as illustrated in FIG. 11, in each hopping resource unit, F pieces of frequency domain units (F=2 in FIG. 11) are defined, and T pieces of time domain units (T=3 in FIG. 11) are defined. Here, each frequency domain unit of the F frequency domain units may be, for example, a sub-channel, a subcarrier, or (sub-)PRB (Physical Resource Block). Each time domain unit of the T time domain units may be a subframe, slot, or TTI.

A hopping pattern is then configured for the hopping resource unit. The hopping pattern can be configured by using different timing shifts for the respective frequency domain units. For example, as illustrated in FIG. 12, a hopping resource unit prior to hopping is denoted as R_{t,f}, and a hopping resource unit after hopping is denoted as R_{t′, f′}. In this case, R_{t′, f′} is obtained by converting t and f of R_{t, f} into t′=(t+αf+β) mod T; and f′=f. FIG. 12 illustrates R_{t, f} and R_{t′, f′} for (α, β)=(2, 1). By configuring multiple combinations of (α, β), a plurality of hopping patterns can be obtained.

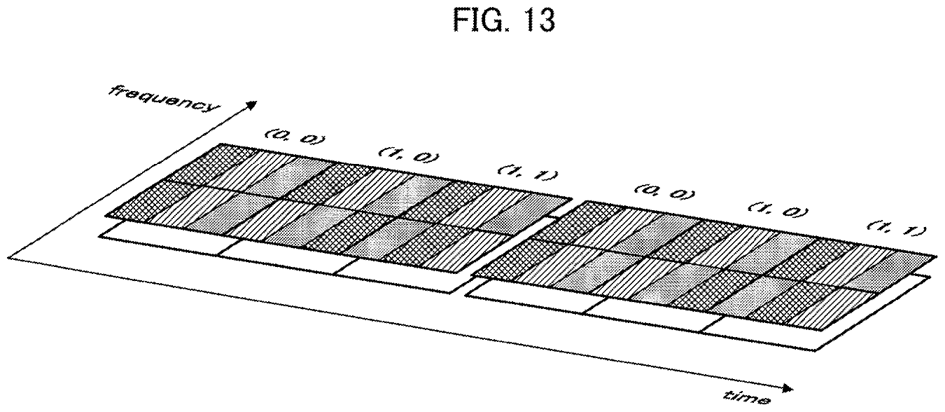

Next, a hopping pattern map is configured using multiple combinations of (α, β). For example, by combining (α, β)=(0, 0), (1, 0), (1, 1), the hopping pattern map as illustrated in FIG. 13 can be configured. In this manner, according to a pre-configured hopping pattern map, the time and frequency location of a transmission resource selected by the communication device 20 in a resource pool can be hopped in a time dependent manner. As a result, even if a plurality of communication devices 20 autonomously selects transmission resources in a resource pool, collisions of the transmission resources can be avoided. In the above-described example, the base station 10 may preconfigure the hopping pattern by a plurality of combinations of (α, β), and the base station 10 may signal the preconfigured hopping pattern to the communication device 20. Alternatively, the hopping pattern map may be configured by randomly selecting a plurality of combinations of (α, β) by the communication device 20

When resource hopping is applied in the communication device 20 at the transmitting side, the data is first mapped onto a transmission resource, and then resource hopping is performed on the transmission resource (hopping pattern map is applied). In this manner, data is transmitted via the transmission resource to which the hopping pattern map is applied. Upon receipt of a signal, the receiving communication device 20 applies an inverse resource hopping (a conversion to restore the original time and frequency resource from the time and frequency resource to which the hopping pattern map has been applied) to the received resource. Subsequently, the data is decoded by demapping the data received via a reception resource.

A pre-configuration may be made as to whether the resource hopping is applied. For example, timing for applying the resource hopping may be preset. Additionally or alternatively, a configuration may be made as to whether the hopping is applied by activation/deactivation signaling (e.g., a MAC layer signal, an RRC layer signal, a physical layer signal, such as SCI or DCI).

In addition to the resource hopping, a timing shift may be applied within a maximum permissible range for a data transmission delay.

Note that, if a plurality of hopping pattern maps is preconfigured, two communication devices may select a same hopping pattern at a certain timing. In this case, for example, the communication device may reselect another hopping pattern from among a plurality of hopping pattern maps in response to detecting in the communication device for which the ratio of failed transmission exceeds a predetermined ratio.

If the above-described method 1 and method 2 are compared, method 1 is considered to have a larger signaling overhead compared to that of method 2. According to method 2, the probability of contention over transmission resources can be reduced. However, according to method 2, there may be a case in which contention of transmission resources remains unsolved.

<Method 3>

As method 3, a method can be considered in which Precoder cycling or Antenna switching is applied. For example, the following methods can be considered: a method in which a beam pattern is randomly changed; a method of applying, in a TDD case, a plurality of beam patterns to a synchronization signal (SLSS) from the communication device 20 at the communication destination, and applying a beam pattern with the maximum received power(RSRP), the maximum received quality (RSRQ, SINR), or the maximum received signal strength indication (RSSI); a method in which, in the communication device 20 at the transmitting side, a plurality of beam patterns is applied to a same signal and the same signal to which the plurality of beam patterns is applied is transmitted to the communication device 20 at the receiving side, and, based on feedback from the communication device 20 at the receiving side, an optimum beam pattern is extracted from the plurality of beam patterns in the communication device 20 at the transmitting side to apply the extracted optimum beam pattern to transmission of data; and a method in which the communication device 20 at the transmitting side applies a plurality of precoders arrange in a predetermined time series to transmission of data.

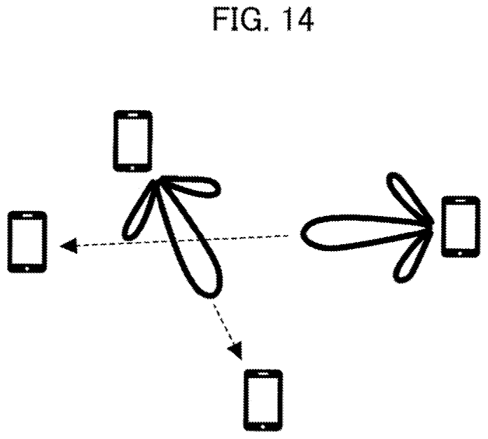

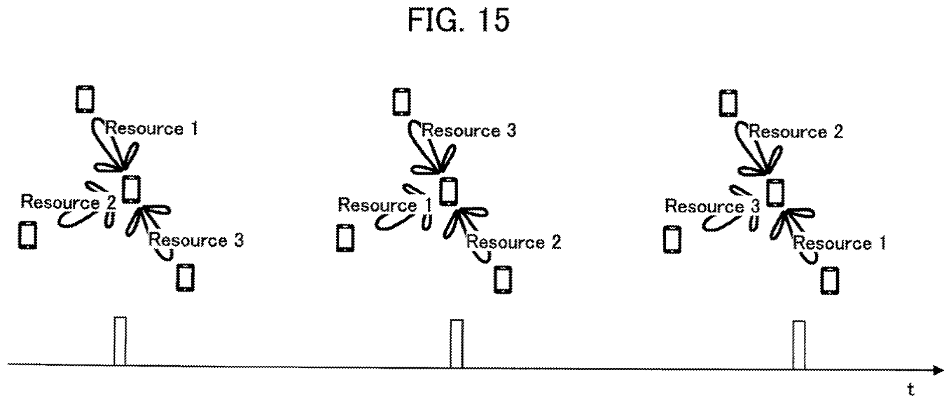

FIGS. 14 and 15 are diagrams illustrating an example of the method of applying the precoder cycling or antenna switching described above.

For applying method 3, the communication device 20 at the transmitting side may apply different beams for respective data items to be transmitted. Alternatively, the communication device 20 may change a beam to be applied in units of a plurality of data items. Here, when a beam to be applied to data transmission is changed, it is necessary that a location of a transmission resource on a frequency axis or a time axis used for transmission of data prior to changing the beam differs from a location of a transmission resource on the frequency axis or the time axis used for transmission of data after changing the beam. (However, a case is excluded in which, for a resource pool (or a resource) that periodically occurs, a transmission resource at a same time and frequency location is selected in the resource pool. In this case, different beams can be periodically applied to the transmission resources at the same time and frequency location. Compared to the previous period, the next period is advanced in time.) Accordingly, a beam change and a transmission resource change may be made simultaneously. For example, a beam change may be combined with the dynamic resource exchange according to method 1. Alternatively, a beam change may be combined with the resource hopping according to method 2.

When a spatial domain filter (Spatial Domain Filter, Spatial Domain Transformation Filter) is used for beamforming, it is necessary to use two or more antenna elements. As a method of performing beamforming using a spatial domain filter, digital beam forming is known in which there are as many Digital Analog Converters (DAC) as transmission antenna elements, and baseband signal processing is performed as many times as the number of the transmission antenna elements. Additionally, analog beamforming is known in which beamforming is achieved using a variable phase shifter in a Radio Frequency (RF) circuit. Furthermore, hybrid beam forming is known in which beamforming processing is implemented by baseband signal processing and a variable phase shifter in a Radio Frequency (RF) circuit by combining digital beamforming and analog beamforming.

However, the method of performing beamforming is not limited to the above-described methods. Typically, an antenna has directivity. For example, if the communication device 20A is provided with two antennas, and the directivities of these two antennas are different, a direction of a transmit beam can be switched by switching between an antenna used at a specific timing and an antenna used at another timing (Antenna Switching).

For example, if the communication device 20 installed in a vehicle is provided with one antenna in front of the vehicle, one antenna at a rear side of the vehicle, one antenna at a right side of the vehicle, one antenna at a left side of the vehicle, and one antenna at an upper side of the vehicle, a direction of a transmit beam can be switched to a front direction, a rear direction, a right direction, a left direction, and an upper direction by switching the antenna to be used to the front antenna, the rear antenna, the right antenna, the left antenna, and the upper antenna, respectively. Here, an example is described in which the antennas are provided at the front side of the vehicle, the rear side of the vehicle, the right side of the vehicle, the left side of the vehicle, and the upper side of the vehicle. However, antennas may be installed at an upper side and a bottom side of the vehicle, or antennas may be installed at a same position. Furthermore, when a plurality of antennas is installed at the same position of the vehicle, an orientation of a part of the plurality of antennas may be different from that of another part of the plurality of antennas. For example, when a plurality of antennas is installed on top of a vehicle, an orientation of a part of the plurality of antennas may be directed in a forward direction and an orientation of another part of the plurality of antennas may be directed in a rearward direction. Furthermore, for example, when a plurality of antennas is installed at the front of a vehicle, a portion of the plurality of antennas may be oriented in a left direction, and another portion of the plurality of antennas may be oriented in a right direction.

Alternatively, for example, if the communication device 20 installed in a vehicle is provided with one or more panels including one or more antenna elements at each of a part at the front of the vehicle, a part at a rear side of the vehicle, a part at a right side of the vehicle, a part at a left side of the vehicle, and a part at an upper side of the vehicle, a direction of a transmission beam can be switched to a front direction, a rear direction, a right direction, a left direction, and an upper direction by switching the panel to be used to the front panel, the rear panel, the right panel, the left panel, and the upper panel (Panel Switching). In this case, the direction of the transmission beam can be switched by applying Panel Switching in addition to switching a precoder applied to each panel. According to the above-described method of switching the panels installed at the front part of the vehicle, the rear part of the vehicle, the right part of the vehicle, the left part of the vehicle, and the upper part of the vehicle, the vehicle itself is a radio wave shield, so that sufficient directivity can be obtained even if the distance between the transmitting communication device 20 and the receiving communication device 20 is short, thereby reducing interference.

Method 1, method 2, and/or method 3 described above may be applied in units of resource pools, in units of carries, in units of cells, in units of zones, or in other units. Method 1, method 2, and/or method 3 described above may be applied quasi-statically or may be applied in response to a trigger.

(Device Configuration)

Next, an example of the functional configurations of the base station 10 and the communication device 20 that execute the processing operation described above is described. The base station 10 and the communication device 20 may include all of the functions of methods 1-3 described in the embodiments, or may include only a part of the functions of methods 1-3.

<The Base Station 10>

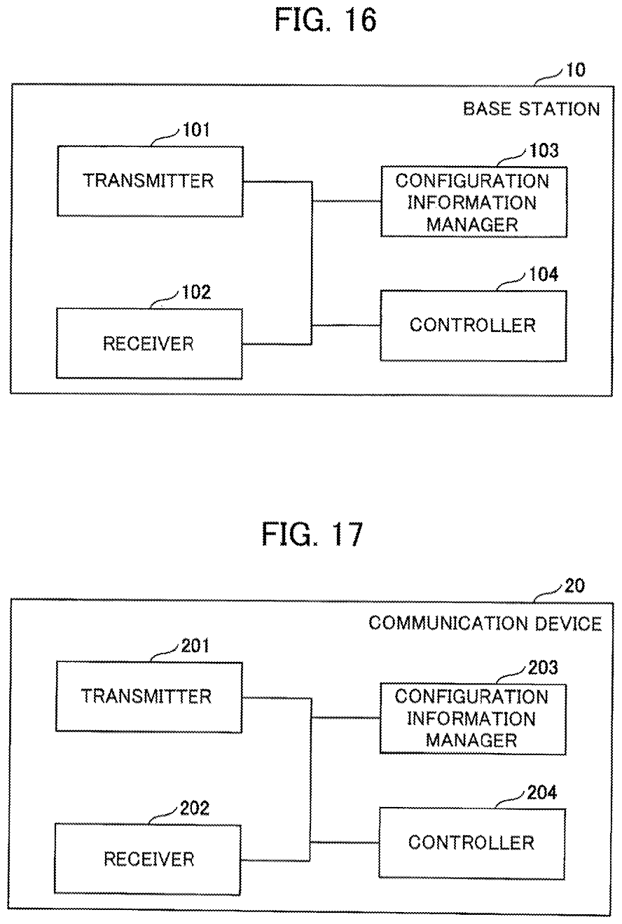

FIG. 16 is a diagram illustrating an example of a functional configuration of the base station 10. As illustrated in FIG. 16, the base station 10 includes a transmitter 101, a receiver 102, a configuration information manager 103, and a controller 104. The functional configuration illustrated in FIG. 16 is only one example. If the operation according to the present embodiment can be executed, functional divisions and names of the functional units may be any divisions and names. The transmitter 101 is referred to as a transmitter, and the receiver 102 may be referred to as a receiver.

The transmitter 101 includes a function of generating a signal to be transmitted to the communication device 20 and transmitting the signal wirelessly. The receiver 102 includes a function for receiving various signals transmitted from the communication device 20 and, for example, retrieving higher layer information from the received signal. The receiver 102 includes a function for measuring the received signal and obtaining a quality value.

The configuration information manager 103 stores the preconfigured configuration information, the configuration information received from the communication device 20, etc. The configuration information related to transmission may be stored in the transmitter 101, and the configuration information related to reception may be stored in the receiver 102. The controller 104 controls the base station 10. The function of the controller 104 related to the transmission may be included in the transmitter 101, and the function of the controller 104 related to the reception may be included in the receiver 102.

For example, the controller 104 is made to configure a transmission resource allocated to the communication device 20. The controller 104 is configured to cause the transmitter 101 to transmit configuration information of a transmission resource allocated to the communication device 20.

The controller 104 may be made to preconfigure the hopping pattern applied to the communication device 20. Additionally, the controller 104 may be configured to cause the transmitter 101 to transmit information representing a hopping pattern applied to the communication device.

<The Communication Device 20>

FIG. 17 is a diagram illustrating an example of the functional configuration of a communication device 20. As illustrated in FIG. 17, the communication device 20 includes a transmitter 201, a receiver 202, a configuration information manager 203, and a controller 204. The functional configuration illustrated in FIG. 17 is only one example. If the operation according to the present embodiment can be executed, functional divisions and names of functional units may be any divisions and names. The transmitter 201 may be referred to as a transmitter, and the receiver 202 may be referred to as a receiver.

The transmitter 201 generates a transmit signal from the transmit data and wirelessly transmits the transmit signal. The receiver 202 receives various signals wirelessly and retrieves a higher layer signal from the received physical layer signal. The receiver 202 includes a function for measuring the received signal and obtaining a quality value.

The configuration information manager 203 stores preconfigured configuration information, configuration information received from the base station 10, etc. The configuration information related to transmission may be stored in the transmitter 201, and the configuration information related to reception may be stored in the receiver 202. The controller 204 controls the communication device 20. The function of the controller 204 related to transmission may be included in the transmitter 201, and the function of the controller 204 related to the reception may be included in the receiver 202.

For example, the controller 204 may be configured to detect that a ratio that is greater than or equal to a predetermined ratio of the plurality of radio resources included in the resource pool is used by another communication device, and may be configured to detect that a ratio of transmission failure becomes greater than or equal to a predetermined ratio.

In addition, the controller 204 may be configured to cause the transmitter 201 to transmit a resource exchange request in response to detecting that a ratio that is greater than or equal to a predetermined ratio of the radio resources included in the resource pool is used by another communication device, or in response to detecting that a ratio of transmission failure becomes greater than or equal to a predetermined ratio.

Additionally, the controller 204 may be configured to include information indicating a radio resource (e.g., information on the time and frequency position of the radio resource) that can be a candidate of the resource exchange in the resource exchange request, and the controller 204 may be configured to cause the transmitter 201 to transmit the resource exchange request.

When the receiver 202 receives information indicating a radio resource that can be a candidate for a resource exchange, the controller 204 may be configured to reselect, as a transmission resource, a radio resource other than the one radio resource that can be a candidate for the resource exchange, if it is possible to select a radio resource other than the one radio resource that can be a candidate for the resource exchange. In this case, the controller 204 may be configured to include information on the time and frequency location of the one radio resource that can be a candidate of the resource exchange in an Acknowledgement signal, and the controller 204 may be configured to cause the transmitter 201 to transmit the Acknowledgement signal.

When the receiver 202 receives information indicating a radio resource that can be a candidate for a resource exchange and does not select a radio resource other than the one radio resource that can be a candidate for the resource exchange, the controller 204 may determine to continue using the one radio resource that can be a candidate for the resource exchange as the transmission resource, and may be configured to cause the transmitter 201 to transmit an Acknowledgment signal including a Negative Acknowledgement.

Furthermore, the controller 204 may be configured so that the controller 204 sets whether resource hopping is applied, based on a pre-configuration, or in response to receiving, by the receiver 202, a notification from the base station 100.

The controller 204 may also be configured to switch a precoder to be applied to data transmission and/or an antenna used for transmitting data (or a panel including a plurality of antenna elements).

<Hardware Configuration>

The block diagrams (FIG. 16 to FIG. 17) used in the description of the above-described embodiments illustrate blocks in units of functions. These functional blocks (components) are implemented by any combination of hardware and/or software. Furthermore, the means for implementing each functional block is not particularly limited. That is, each functional block may be implemented by one device with a physical and/or logical combination of elements, or may be implemented by two or more devices while directly and/or indirectly (e.g., wired and/or wireless) connecting the two or more devices that are physically and/or logically separated.

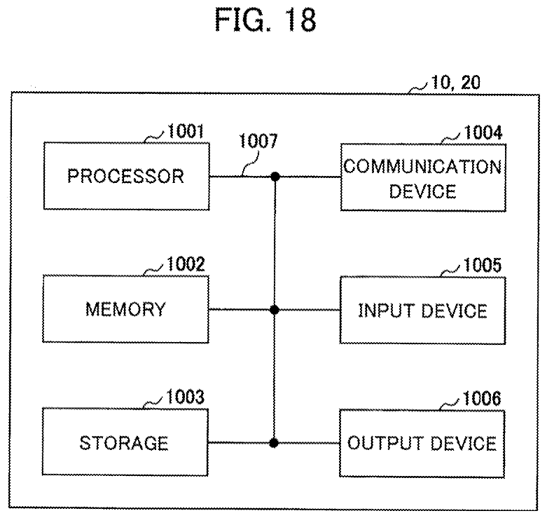

For example, each of the communication device 20 and the base station 10 according to one embodiment of the present invention may function as a computer performing the process according to this embodiments. FIG. 18 is a diagram illustrating an example of a hardware configuration of the communication device 20 and the base station 10 according to the embodiment. Each of the above-described communication device 20 and base station 10 may be physically configured as a computer device including a processor 1001, a memory 1002, a storage 1003, a communication device 1004, an input device 1005, an output device 1006, a bus 1007, etc.

In the following description, the term “device” can be read as a circuit, a device, a unit, etc. The hardware configuration of the communication device 20 and base station 10 may be configured to include one or more of the devices denoted by 1001-1006 in the figure, or may be configured without some devices.

Each function of the communication device 20 and the base station 10 is implemented by loading predetermined software (program) on hardware, such as the processor 1001 and the memory 1002, so that the processor 1001 performs computation and controls communication by the communication device 1004, and reading and/or writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, etc.

Additionally, the processor 1001 reads a program (program code), a software module or data from the storage 1003 and/or the communication device 1004 to the memory 1002, and executes various processes according to these. As the program, a program is used which causes a computer to execute at least a part of the operations described in the above-described embodiment. For example, the transmitter 101, the receiver 102, the configuration information manager 103, and the controller 140 of the base station 10 illustrated in FIG. 16 may be implemented by a control program that is stored in the memory 1002 and operated by the processor 1001. For example, the transmitter 201, the receiver 202, the configuration information manager 203, and the controller 204 of the communication device 20 illustrated in FIG. 17 may be implemented by a control program stored in the memory 1002 and operated by the processor 1001. While the various processes described above are described as being executed in one processor 1001, they may be executed simultaneously or sequentially by two or more processors 1001. Processor 1001 may be implemented by one or more chips. The program may be transmitted from the network via a telecommunications line.

The memory 1002 is a computer readable storage medium, and, for example, the memory 1002 may be formed of at least one of a ROM (Read Only Memory), an EPROM (Erasable Programmable ROM), an EEPROM (Electrically Erasable Programmable ROM), a RAM (Random Access Memory), etc. The memory 1002 may be referred to as a register, a cache, a main memory (main storage device), etc. The memory 1002 may store a program (program code), a software module, etc., which can be executed for implementing the process according to one embodiment of the present invention.

The storage 1003 is a computer readable storage medium and may be formed of, for example, at least one of an optical disk, such as a CD-ROM (Compact Disc ROM), a hard disk drive, a flexible disk, an optical magnetic disk (e.g., a compact disk, a digital versatile disk, a Blu-ray (registered trademark) disk, a smart card, a flash memory (e.g., a card, a stick, a key drive), a floppy (registered trademark) disk, a magnetic strip, etc. The storage 1003 may be referred to as an auxiliary storage device. The above-described storage medium may be, for example, a database including memory 1002 and/or storage 1003, a server, or any other suitable medium.

The communication device 1004 is hardware (transmitting and receiving device) for performing communication between computers through a wired and/or wireless network, and is also referred to, for example, as a network device, a network controller, a network card, a communication module, etc. For example, the transmitter 201 and the receiver 201 of the communication device 20 may be implemented by the communication device 1004. The transmitter 101 and the receiver 102 of the base station 10 may be implemented by the communication device 1004.

The input device 1005 is an input device (e.g., a keyboard, a mouse, a microphone, a switch, a button, a sensor, etc.) that receives an external input. The output device 1006 is an output device (e.g., a display, speaker, LED lamp, etc.) that performs output toward outside. The input device 1005 and the output device 1006 may be configured to be integrated (e.g., a touch panel).

Each device, such as processor 1001 and memory 1002, is also connected by the bus 1007 for communicating information. The bus 1007 may be formed of a single bus or may be formed of different buses between devices.

Communication device 20 and base station 10 may each include hardware, such as a microprocessor, a digital signal processor (DSP), an ASIC (Application Specific Integrated Circuit), a PLD (Programmable Logic Device), and a FPGA (Field Programmable Gate Array), which may implement some or all of each functional block. For example, processor 1001 may be implemented by at least one of these hardware components.

### Conclusion of the Embodiments

In this specification, at least the communication devices described below are disclosed.

<Item 1>

A communication device includes a transmitter that transmits data; and a controller that generates, in response to a predetermined trigger, a request signal including information on a time and frequency location of a radio resource to be used by the transmitter.

<Item 2>

In the communication device, the predetermined trigger is at least one of the following: detecting that, from a plurality of radio resources included in a resource pool, a ratio of radio resources that is greater than or equal to a predetermined ratio of radio resources is used by another communication device; and a ratio of transmission failure becoming greater than or equal to a predetermined ratio.

<Item 3>

The communication device, further includes a receiver that receives data, wherein, in response to receiving, by the receiver, positive acknowledgement information, the controller selects the radio resource to be used, as a transmission resource.

<Item 4>

In the communication device, in response to receiving, by the controller, negative acknowledgement information, the controller reselects a certain radio resource other than the radio resource to be used.

<Item 5>

A communication device includes a receiver that receives data; a controller that reselects, in response to receiving, by the receiver, a request signal including information on a time and frequency location of a first radio resource, a second radio resource other than the first radio resource, as a transmission resource; and a transmitter that transmits, in response to reselecting, by the controller, the second radio resource other than the first radio resource as the transmission resource, a signal including positive acknowledgement information.

<Item 6>

In the communication device, in response to receiving the request signal including the information on the time and frequency location of the radio resource, the controller reselects the radio resource as the transmission resource, and the transmitter transmits a signal including negative acknowledgment information in response to reselecting, by the controller, the radio resource as the transmission resource.

<Item 7>

A communication device includes a transmitter that transmits data; and a controller that applies, in response to a predetermined trigger, a hopping pattern to a transmission resource, and that causes, when the transmitter transmits the data, the transmitter to use the transmission resource to which the hopping pattern is applied.

<Item 8>

In the communication device, the controller switches a beam used for transmitting data on a data to be transmitted-by-data to be transmitted basis, or the controller switches a beam used for transmitting a plurality of data items in units of the plurality of data items to be transmitted.

According to any configuration of item 1 through item 8 described above, a technique is provided that can reduce a probability of a collision of transmission resources for transmitting data in D2D communication.

### Supplemental Embodiments

While the embodiments of the present invention are described above, the disclosed invention is not limited to the embodiments, and those skilled in the art will appreciate various alterations, modifications, alternatives, substitutions, etc. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied (unless inconsistent) to the items described in another item. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiment, the order of processing may be changed as long as there is no inconsistency. For the convenience of the description of the process, the communication device 20 and the base station 10 are described using functional block diagrams, but such devices may be implemented in hardware, software, or a combination thereof. Software operated by a processor in accordance with embodiments of the present invention and software operated by a processor in accordance with embodiments of the present invention may be stored in a random access memory (RAM), a flash memory (RAM), a read-only memory (ROM), an EPROM, an EEPROM, a register, a hard disk (HDD), a removable disk, a CD-ROM, a database, a server, or any other suitable storage medium, respectively.

Notification of information is not limited to the aspects/embodiments described in this specification, and notification of information may be made by another method. For example, notification of information may be implemented by physical layer signaling (e.g., DCI (Downlink Control Information), UCI (Uplink Control Information), higher layer signaling (e.g., RRC (Radio Resource Control) signaling, MAC (Medium Access Control) signaling, broadcast information (MIB (Master Information Block), SIB (System Information Block))), or other signals or combinations thereof. RRC signaling may be referred to as an RRC message, for example, which may be an RRC connection setup message, an RRC connection reconfiguration (RRC Connection Reconfiguration), etc.

The aspects/embodiments described in this specification may be applied to a system using LTE (Long Term Evolution), LTE-A (LTE-Advanced), SUPER 3G, IMT-Advanced, 4G, 5G, FRA (Future Radio Access), W-CDMA (Registered Trademark), GSM (Registered Trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (Registered Trademark), or any other appropriate system, and/or a next generation system extended based on theses.

The processing procedures, sequences, flow charts, etc. of each aspect/embodiment described herein may be reordered, provided that there is no contradiction. For example, the methods described in this specification present elements of various steps in an exemplary order and are not limited to the particular order presented.

The particular operation described in this specification to be performed by base station 10 may be performed by an upper node in some cases. It is apparent that in a network consisting of one or more network nodes having base stations 10, various operations performed for communicating with communication device 20 may be performed by base stations 10 and/or other network nodes other than base stations 10 (e.g., MME or S-GW can be considered, however, the network node is not limited to these). The case is exemplified above in which there is one network node other than the base station 10. However, the network node other than the base station 10 may be a combination of multiple other network nodes (e.g., MME and S-GW).

The aspects/embodiments described in this specification may be used alone, may be used in combination, or may be switched during execution.

The communication device 20 may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

The base station 10 may be referred to by one of ordinary skill in the art as NB (NodeB), eNB (enhanced NodeB), base station (Base Station), gNB, or some other suitable terms.

The terms “determine (determining)” and “decide (determining)” used in this specification may include various types of operations. For example, “determining” and “deciding” may include deeming that a result of calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input, output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The phrase “based on” used in this specification does not imply “based solely on” unless otherwise specified. In other words, “based on” means both “based solely on” and “at least based on.”

The terms “include (include)” “including (including),” and variants thereof are used in this specification or in the claims, these terms are intended to be inclusive, similar to the term “comprising.” Furthermore, it is intended that the term “or” as used in this specification or in the claims is not an exclusive logical sum.

Throughout the present disclosure, if an article is added by translation, such as “a,” “an”, and “the” in English, these articles may include a plurality of things unless as otherwise indicated by the context clearly.

The present invention is described in detail above. It is apparent to those skilled in the art that the present invention is not limited to the embodiments described in this specification. The present invention can be implemented as modifications and alterations without departing from the gist and scope of the present invention as defined by the claims. Accordingly, the descriptions in this specification is intended for illustrative purposes and does not have any restrictive meaning to the present invention.

### LIST OF REFERENCE SYMBOLS

101 transmitter
102 receiver
103 configuration information manager
104 controller
201 transmitter
202 receiver
203 configuration information manager
204 controller
1001 processor
1002 memory
1003 storage
1004 communication device
1005 input device
1006 output device

1. A communication device comprising:
a transmitter that transmits data; and
a controller that generates, in response to a predetermined trigger, a request signal including information on a time and frequency location of a radio resource to be used by the transmitter.

2. The communication device according to claim 1, wherein the predetermined trigger is at least one of the following:
detecting that, from a plurality of radio resources included in a resource pool, a ratio or radio resources that is greater than or equal to a predetermined ratio of radio resources is used by another communication device; and
a ratio of transmission failure becoming greater than or equal to a predetermined ratio.

3. The communication device according to claim 1, further comprising:
a receiver that receives data,
wherein, in response to receiving, by the receiver, positive acknowledgement information, the controller selects the radio resource to be used, as a transmission resource.

4. A communication device comprising:
a receiver that receives data;
a controller that reselects, in response to receiving, by the receiver, a request signal including information on a time and frequency location of a first radio resource, a second radio resource other than the first radio resource, as a transmission resource; and
a transmitter that transmits, in response to reselecting, by the controller, the second radio resource other than the first radio resource as the transmission resource, a signal including positive acknowledgement information.

5. A communication device comprising:
a transmitter that transmits data; and
a controller that applies, in response to a predetermined trigger, a hopping pattern to a transmission resource, and that causes, when the transmitter transmits the data, the transmitter to use the transmission resource to which the hopping pattern is applied.

6. The communication device according to claim 5, wherein the controller switches a beam used for transmitting data on a data to be transmitted-by-data to be transmitted basis, or the controller switches a beam used for transmitting a plurality of data items in units of the plurality of data items to be transmitted.
